(19) United States
(12) Patent Application Publication
(10) Pub. No.: US 2003/0074827 A1
(43) Pub. Date: Apr. 24, 2003

(54) Tangle free fishing pole

(76) Inventors: Mark R. Maguire, Fort Wayne, IN (US); Cynthia A. Maguire, Fort Wayne, IN (US); Daniel E. Morken, Fort Wayne, IN (US); Rebecca L. Morken, Fort Wayne, IN (US)

Correspondence Address: TAYLOR & AUST, P.C., 142 S. Main St., P.O. Box 560, Avilla, IN, 46710, US

(21) Appl. No.: 10/196,615

(22) Filed: Jul. 16, 2002

Related U.S. Application Data
(63) Continuation-in-part of application No. 09/982,635, filed on Oct. 18, 2001.

(51) Int. Cl. A01K 87/04

(52) U.S. Cl. 43/24

(57) ABSTRACT

A fishing pole enhancement kit including a modified line guide, a reel cover and an elongated tube configured to be detachably connected to the modified line guide and to the reel cover.

### CROSS REFERENCE TO RELATED APPLICATIONS

This is a continuation-in-part of U.S. patent application Ser. No. 09/982,635, entitled “TANGLE FREE FISHING POLE” filed Oct. 18, 2001.

### BACKGROUND OF THE INVENTION

1. Field of the Invention

The present invention relates to a fishing pole, and, more particularly, to a tangle free fishing pole.

2. Description of the Related Art

Mankind has pursued fishing for survival, for commercial purposes and for sport. The pursuit of the sport of fishing has produced a plethora of products in the way of boating innovations, fish finders, lures, fishing lines, reels and fishing rods.

The basic equipment of fishing consists of a barbed metal hook at the end of a filament, woven line or metal line and a wood, fiberglass or metal rod or pole, that usually has some type of spool or reel, near the handle around which the fishing line is wound. Recreational fishing is practiced throughout the world and is done in freshwater and saltwater. The most popular game fish are salmon, trout, bass and pike in freshwater, and sailfish, tuna, marlin, tarpon and bonefish in saltwater. There are two basic types of freshwater tackle, those for fly casting and those for bait casting.

Live bait or a variety of plugs, spoons, and other artificial lures can be cast and pulled in, popped along the surface, trolled from a moving boat or allowed to rest near the bottom. Spinning tackle, which is also very popular, requires the angler to keep the lure moving by repeatedly casting the spinning tackle and reeling it back in.

Fishing poles, which are configured for bait casting, generally have a reel with some device to release fishing line from the reel as the pole is moved through a casting motion. The mass of the lure, bait and/or other tackle secured to the end of the fishing line is utilized during the casting motion, by way of the inertia imparted, to pull the line from the reel to a point of entry in the water. A skilled fisherman can accurately cast the fishing pole to place the lure in a desired location.

A fisherman experiences a great deal of annoyance when his fishing line tangles, but particularly when it tangles on the fishing rod. Twisting and tangling of fishing line most often occurs as a person is preparing to cast or during the casting process. Excessive slack in the fishing line also contributes to a tangling problem. Even though novice fishermen are most adept at tangling their fishing line, every angler has experienced the problem. Particularly frustrating to the experienced angler is fishing with a novice who requires repeated attention to untangle fishing line from their fishing pole.

What is needed in the art of fishing is an apparatus to eliminate the tangling of fishing line.

### SUMMARY OF THE INVENTION

The present invention provides a tangle free fishing pole having a flexible tube, captivated between fishing line guides, for the routing of fishing line therethrough.

The invention comprises, in one form thereof, a fishing pole enhancement kit including a modified line guide, a reel cover and an elongated tube configured to be detachably connected to the modified line guide and to the reel cover.

An advantage of the present invention is that it eliminates tangling of a fishing line on a fishing rod during the casting process.

Another advantage is that it eliminates tangling of fishing line during storage of a fishing rod.

Yet another advantage is that the present invention eliminates slack in the fishing line

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a side view of a tangle free fishing pole embodying the present invention;

FIG. 2 is an expanded side view of a portion of the tangle free fishing pole of FIG. 1;

FIG. 3 is a perspective view of a captivating device of the tangle free fishing pole of FIGS. 1 and 2;

FIG. 4 is a side view of a lead line for use with the tangle free fishing pole of FIGS. 1-3;

FIG. 5 is a perspective side view of a tangle free fishing pole of another embodiment of the present invention; and

FIG. 6 is an exploded perspective view of an adapter kit of the tangle free fishing pole of FIG. 5.

Corresponding reference characters indicate corresponding parts throughout the several views. The exemplifications set out herein illustrate one preferred embodiment of the invention, in one form, and such exemplifications are not to be construed as limiting the scope of the invention in any manner.

### DETAILED DESCRIPTION OF THE INVENTION

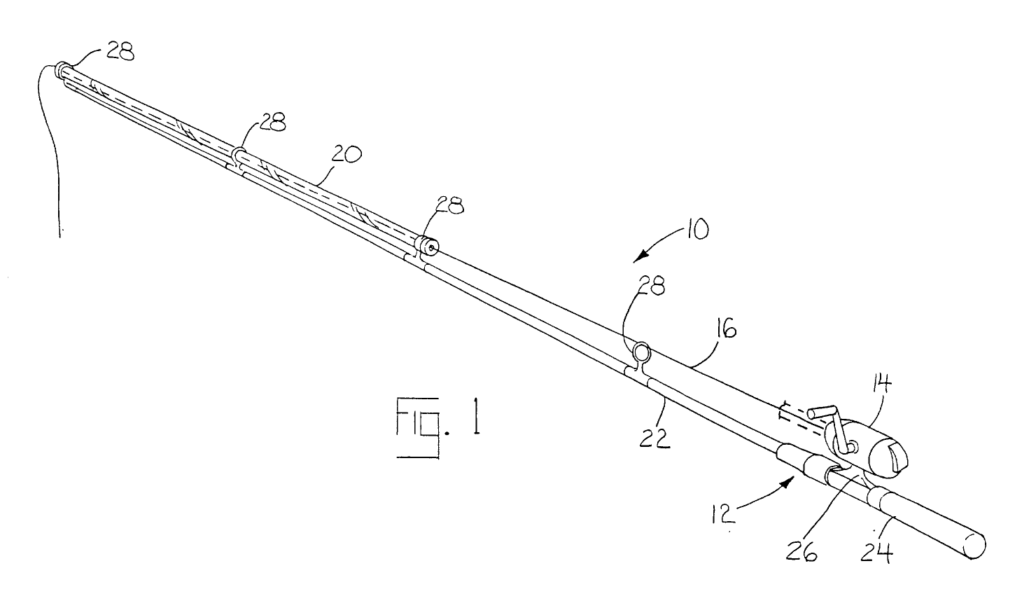

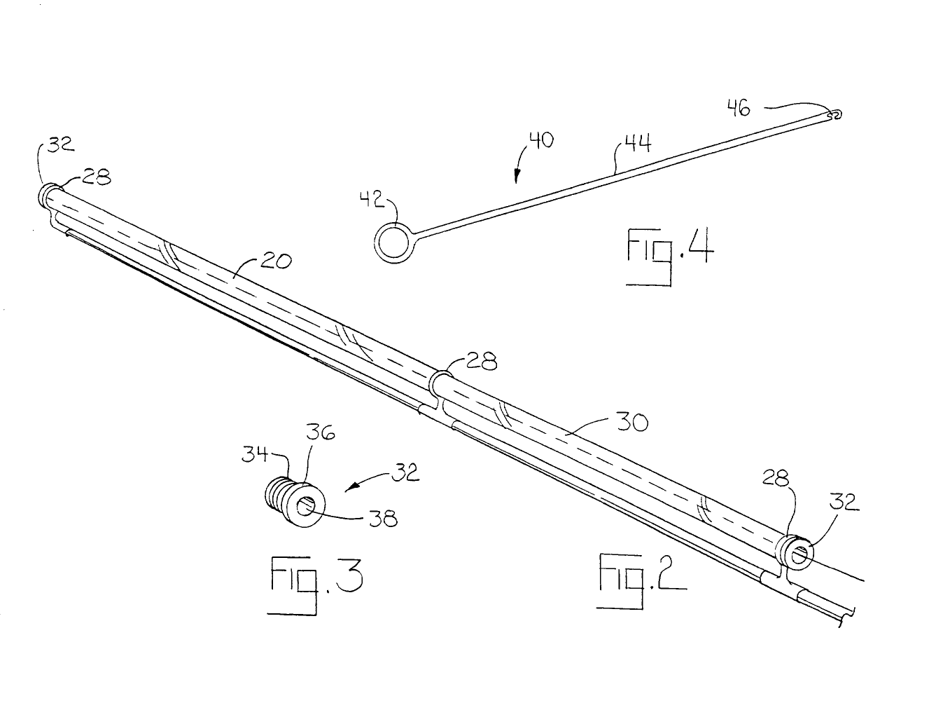

Referring now to the drawings, and more particularly to FIGS. 1 and 2, there is shown a tangle free fishing pole 10 which generally includes a fishing rod 12, a reel 14, fishing line 16 and fishing line containment apparatus 20.

Fishing rod 12 includes shaft 22, handle 24, reel mount 26 and line guides 28. Shaft 22 is a flexible shaft which assists in the casting of fishing line 16 and provides tension on fishing line 16 during the retrieval of fishing line 16. The flexibility of shaft 22 is selected based on the type of fish sought and the fisherman's preferences. Handle 24 is attached to one end of shaft 22. Located at a position next to handle 24 is reel mount 26. Along the length of shaft 22 are located line guides 28. Line guides 28 are spaced to accommodate fishing line 16.

Handle 24 is attached to an end of shaft 22 to provide an ergonomic grip to the user of fishing rod 12. Handle 24 is cushioned and made of a slip resistant material. Reel mount 26 is mounted adjacent to handle 24 in order to place reel 14 proximate handle 24 thereby facilitating the use of reel 14 by the user. Line guides 28 are located along shaft 22 having openings therethrough to provide for the guiding of fishing line 16 along the length of shaft 22. Line guides 28 are well known in the art and are affixed to shaft 22.

Reel 14 is a casting type of reel which is configured to contain fishing line 16 for release upon a coordinated casting action and actuation of reel 14 by the user. Reel 14 is used to retrieve fishing line 16 and to store fishing line 16 thereon.

Fishing line 16 is a filament, a woven line or a metal line. Fishing line 16 is stored on reel 14 and released by a user in a casting motion to cast a bait or lure into water.

Fishing line containment apparatus 20 includes elongated tube 30 and captivating devices 32. Fishing line containment apparatus 20 can extend from any line guide 28 to any other line guide 28. Fishing line containment apparatus 20 provides for the passage of fishing line 16 therethrough. The passage of fishing line 16 through fishing line containment apparatus 20 controls the flow of fishing line 16, preventing the contact of the portion of fishing line 16 therein with another portion of fishing line 16, thereby eliminating tangling of fishing line 16.

Elongated tube 30 is a hollow tubing that is flexible such that the overall flexibility of fishing rod 12 is not substantially altered. Elongated tube 30 may be made of plastic, vinyl, fiberglass, rubber, graphite or metal. Elongated tube 30 may be transparent, translucent or opaque of any color and include glow in the dark compounds. The outer diameter of elongated tube 30 is such that it will pass through line guides 28. The length of elongated tube 30 is selected to proceed through as many line guides 28 as is desired. Each end of elongated tube 30 is secured to a line guide by captivating device 32 or elongated tube 30 may be captivated to shaft 22 in another manner thereby eliminating the need for line guides altogether. Alternatively, elongated tube 30 may be a coil spring. Alternatively, elongated tube 30 may have one end captivated to line guide 28 by way of a captivating device 32 and an other end routed to reel 14 and captivated thereto by an other captivating device 32 as shown by phantom lines in FIG. 1. Attaching elongated tube 30 to reel 14 also eliminates slack in line 16 ahead of reel 14.

Now, additionally referring to FIG. 3, captivating devices 32 are a ferrule have a tubular section 34, a shoulder section 36 and an axial hole 38 therethrough. The ends of elongated tube 30 are disposed near the openings of line guides 28 and captivating devices 32 are attached to elongated tube 30 by going through line guides 28. Tubular section 34 is sized to be detachably inserted into elongated tube 30. Tubular section 34 has raised annular rings on the outer surface to retain elongated tube 30. Alternatively, tubular section 34 may retain elongated tube 30 using a crimp or an adhesive. Shoulder section 36 is circular in shape and is sized to not pass through the opening of line guide 28. Axial hole 38 is cylindrical and is substantially centered on the axis of captivating device 32. Fishing line 16 travels through a captivating device 32, elongated tube 30 and an other captivating device 32.

In another embodiment of the present invention, there is provided a kit for the modification of a fishing rod, including elongated tube 30 and at least two captivating devices 32.

A user obtains the kit for installation on fishing rod 12. The user measures the needed length of elongated tube 30 and cuts elongated tube 30 to a desired length. An end of the properly sized elongated tube 30 is positioned next to a line guide 28 and from the opposite side of line guide 28 a captivating device 32 is inserted into elongated tube 30, thereby drawing an end of elongated tube 30 into the opening of a line guide 28. An other end of elongated tube 30 is routed through any intervening line guides 28 and an other captivating device 32 is inserted into elongated tube 30 thereby resulting in elongated tube 30 being secured on each end to a line guide 28 of fishing rod 12. Alternatively, one end of elongated tube 30 may be secured to reel 14 with a captivating device 32.

Now, additionally referring to FIG. 4, there is depicted lead line 40 which is another aspect of the present invention. Lead line 40 includes handle 42, body 44 and eyelet 46. Lead line 40 provides for the threading of fishing line 16 through fishing line containment apparatus 20. Lead line 40 is inserted through fishing line containment apparatus 20, fishing line 16 is threaded through eyelet 46 and lead line 40 is withdrawn from fishing line containment apparatus 20 thereby threading fishing line 16 through fishing line containment apparatus 20.

Handle 42 is a substantially circular loop allowing a user to conveniently grasp the end of lead line 40 and allows a user to attach lead line 40 to a cord (not shown) in order to prevent loss of lead line 40.

Body 44 is a substantially cylindrical element, of a diameter smaller than the interior diameter of elongated tube 30. Attached at one end of body 44 is handle 42 and at an other end of body 44 is eyelet 46.

Eyelet 46 is a hole through the side of body 44 toward an end of body 44 opposite handle 42. Eyelet 46 accommodates the threading of an end of fishing line 16 therethrough. Alternatively, eyelet 46 may also have a slot extending from eyelet 46 to the side of body 44, thereby allowing fishing line 16 to be inserted sideways into eyelet 46.

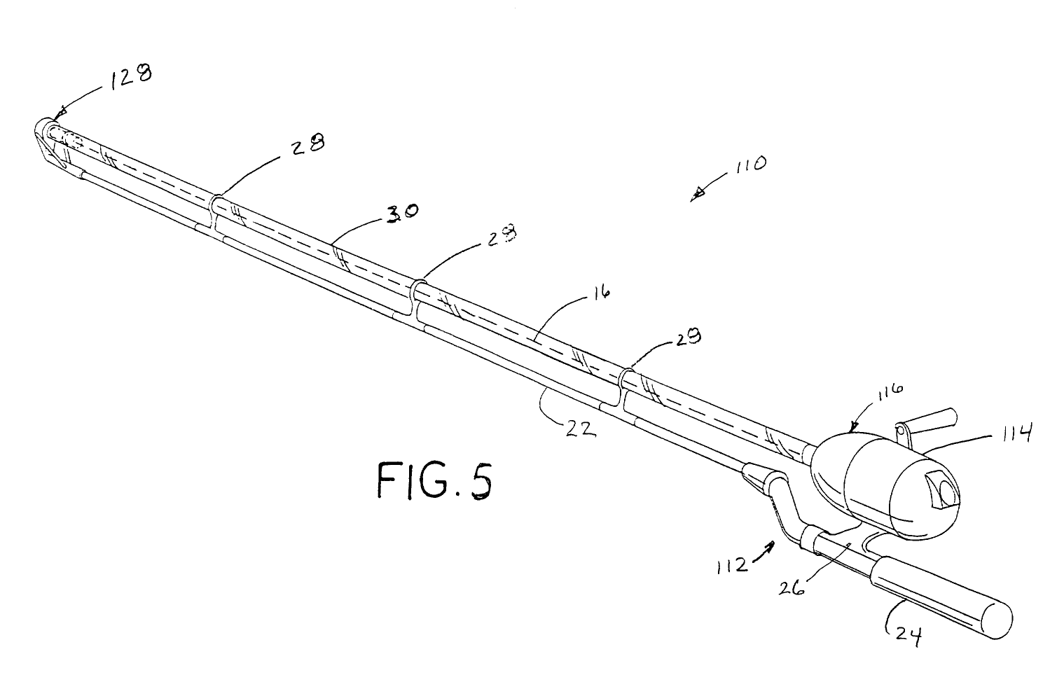

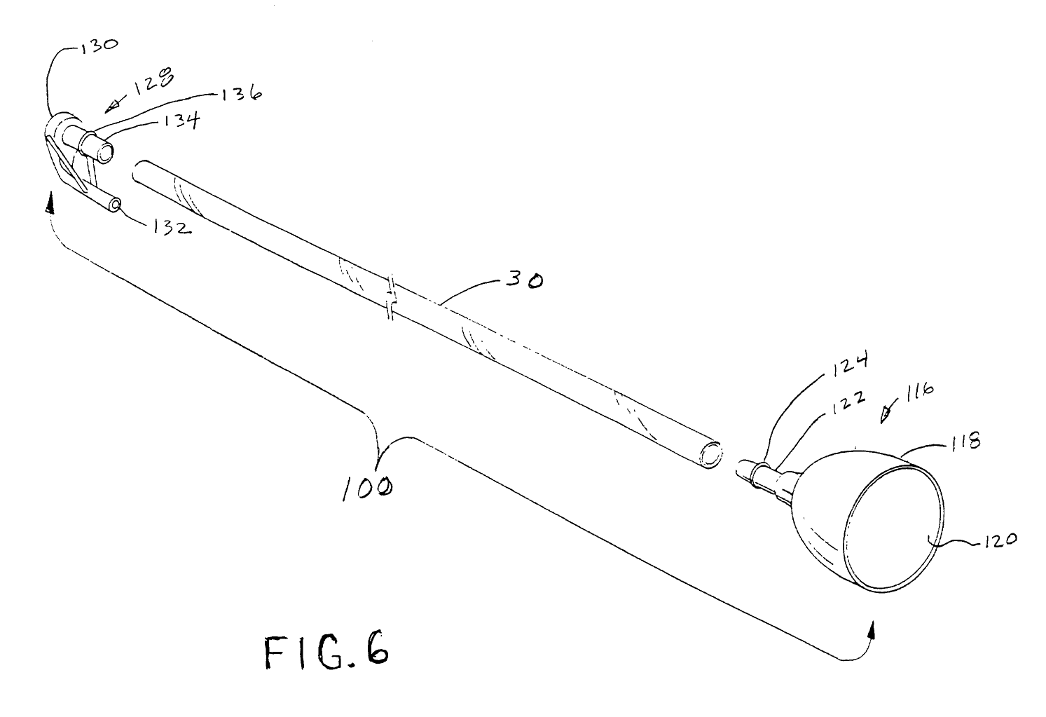

Now additionally referring to FIGS. 5 and 6 there is shown a tangle free fishing pole 110 which generally includes modified fishing rod 112, adapted reel 114 and full length tangle free kit 100.

Modified fishing rod 112 is similar to fishing rod 12 and includes shaft 22, handle 24, reel mount 26, line guides 28 and modified line guide 128. Attached to a distal end of shaft 22 is modified line guide 128, which replaces an end line guide 28 on a conventional fishing rod.

Adapted reel 114 includes reel attachment 116, also known as reel cover 116, having bell housing 118, reel interface 120, directing tube 122 and retaining protrusion 124. Bell housing 118 is shaped to accommodate the inner workings of adapted reel 114. Reel interface 120 is shaped and contains the lugs and/or adhesive to removably connect reel attachment 116 to adapted reel 114. Directing tube 122 is attached to one end of bell housing 118 allowing fishing line 16 to traverse therethrough. Retaining protrusion 124 is positioned upon directing tube 122 to provide a securable attachment for elongated tubing 30. Elongated tubing 30 is slipped onto directing tube 122, over the top of retaining protrusion 124 to thereby be removably secured to reel attachment 116. Alternatively, elongated tubing 30 may be further secured to reel attachment 116 by the use of a clamp over the top of elongated tubing 30.

Modified line guide 128 includes tube support 130, fishing rod connection 132, directing tube 134 and retaining protrusion 136. Tube support 130 is connected, in a permanent manner, to directing tube 134. Fishing rod connection 132 is similar to a conventional line guide on a fishing rod in that fishing rod connection 132 is mounted to shaft 22. Directing tube 134 is hollow thereby allowing fishing line 16 to traverse therethrough. Around an outer circumference of directing tube 134 is retaining protrusion 136. Elongated tubing 30 is routed through line guides 28 to modified line guide 128 and is inserted over directing tube 134. As elongated tubing 30 is pressed onto directing tube 134 it is also pressed over the top of retaining protrusion 136 thereby removably securing elongated tubing 30 to modified line guide 128.

Full-length tangle free kit 100 generally includes reel attachment 116, elongated tubing 30 and modified line guide 128. Elongated tubing 30 may be in the form of a clear plastic tube of a length that can be trimmed by the installer. Reel attachment 116 may be specific to a particular reel or universal in nature and may be adaptable to many types of reels such as reel 114. Modified line guide 128 is universal in nature and may fit several diameters of shafts 22 either by adhesive, a stepped interior diameter or adapter shims to thereby adapt fishing rod connection 132.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A tangle free fishing pole, comprising:
a modified line guide;
a fish pole having said modified line guide attached to one end thereof; and
a fishing line containment apparatus attached to said modified line guide.

2. The fishing pole of claim 1, wherein said fishing line containment apparatus comprises an elongated tube.

3. The fishing pole of claim 2, wherein said elongated tube is flexible.

4. The fishing pole of claim 2, wherein said elongated tube is made of at least one of plastic, vinyl, fiberglass, rubber, graphite and metal.

5. The fishing pole of claim 2, wherein said elongated tube is a coiled spring.

6. The fishing pole of claim 2, wherein said modified line guide has at least one annular ring on an exterior surface.

7. The fishing pole of claim 1, further comprising a lead line for withdrawable insertion through said fishing line containment apparatus.

8. The fishing pole of claim 1, further comprising:
a fishing reel removably connected to said fish pole; and
a reel cover removably connected to said fishing reel.

9. The fishing pole of claim 8, wherein said reel cover is connected to said fishing line containment apparatus.

10. A fishing pole enhancement kit comprising:
a modified line guide;
a reel cover; and
an elongated tube configured to be detachably connected to said modified line guide and to said reel cover.

11. The kit of claim 10, wherein said elongated tube is flexible.

12. The kit of claim 10, wherein said elongated tube is made of at least one of plastic, vinyl, fiberglass, rubber, graphite and metal.

13. The kit of claim 10, wherein said elongated tube is a coiled spring.

14. The kit of claim 10, wherein said modified line guide has at least one captivating protrusion configured to retain said elongated tube.

15. The kit of claim 10, wherein said reel cover has at least one captivating protrusion configured to retain said elongated tube.

16. The kit of claim 10, further comprising a lead line for withdrawable insertion through said elongated tube.

17. The kit of claim 10, further comprising a fishing reel, said reel cover detachably connected to said fishing reel.

18. A method of enhancing a fishing rod, comprising the steps of:
providing a fishing rod having a modified fishing line guide;
attaching a fishing reel to said fishing rod, said fishing reel having a reel cover; and
connecting flexible tubing between said modified fishing line guide and said reel cover.

19. The method of claim 18, further comprising the step of using a lead line to thread a fishing line through said flexible tubing.
